(19) United States
(12) Patent Application Publication
(10) Pub. No.: US 2015/0004570 A1
(43) Pub. Date: Jan. 1, 2015

(54) BLOCK TOY FOR LEARNING FOREIGN LANGUAGES

(71) Applicant: Seung Ki NOH, (US)

(72) Inventor: Seung Ki Noh, Ansan-si (KR)

(21) Appl. No.: 14/370,146

(22) PCT Filed: Dec. 14, 2012
(86) PCT No.: PCT/KR2012/010878

§ 371 Date: Jul. 1, 2014

(30) Foreign Application Priority Data
Feb. 13, 2012 (KR) 10-2012-0014114

(51) Int. Cl. A63F 3/04; A63H 33/04; G09B 19/06

(52) U.S. Cl. CPC A63F 3/0402; G09B 19/06; A63H 33/04
USPC 434/157

(57) ABSTRACT

The present invention relates to a block toy for learning a foreign language. The block toy for learning a foreign language includes word cards which have one or more geometrically-shaped coupling means and also words written thereon, and grammar blocks which have one or more geometrically-shaped corresponding coupling means that corresponds to the coupling means of the word cards and also have word card receiving portions for receiving the word cards, wherein the coupling means of the word cards and the corresponding coupling means are fitted together in the word card receiving portions, and thus the word cards are inserted into the grammar blocks.

### TECHNICAL FIELD

The present invention relates to an educational aid or toy for learning a foreign language.

### BACKGROUND ART

The world is rapidly expanding these days. Local economies in the world are consolidated into “the one global village”. Development in transportation, communication means, and democracy has removed the physical borders between countries as well as races. People are free to visit each other regardless of the borders. This is a social and cultural exchange instead of an accidental meeting between people. Accordingly, communication becomes an urgent issue to be solved. Communication depends upon languages, and thus learning foreign languages is greatly required, especially learning English is considered important. English is regarded as a factor having a wide influence on finding a job as well as a success in life. Each person invests a large amount of money and time in improving his or her English. Consequently, an English learning market is naturally formed (hereinafter, English is referred to represent foreign languages), and the market grows in size day by day. Private English education, a service of learning foreign languages using a communication means, language training in foreign countries, and studying abroad are usable methods for learning English. In addition, the government and public organizations greatly expand investment in learning English.

English has been taught on the basis of four skills, that is, listening, reading, writing, and speaking. To learn languages with letters regardless of foreign and native languages, the four language skills are required to be evenly improved. Although English education has been conducted that focus on grammar for a long time, an opinion in which grammar is useless is recently raised because practical speaking becomes more important than grammar. As a result, opinion opposing against grammar education is noticeably formed. However, grammar that teaches a basic system of a language plays an important role in foreign language education when people learn foreign languages. Kids are capable of simply expressing themselves, however communication between adults significantly requires reliability of expressions, exact comprehension, and power of persuasion. And they depend upon exact grammar skills. Especially, results in grammar education are regarded as extremely important in the business world regarding trust as important as well as environments requiring a high level of communication skills.

However, grammar education is not resultful for all the learners. In an environment in which people teach and learn English as foreigners, grammatical differences between English and the native language causes difficulties in teaching and learning English, and grammar education is hard to continuously be conducted because of difficulties itself. Accordingly, a number of English grammar educators have tried to raise learners' interest. A large amount of efforts have been made to understand characteristics of learners and develop a variety of learning models suitable for cognitive development stages and language learning principles.

However, the learning models for grammar education usually focus on teaching materials or teaching methods. Although education focusing on teaching materials or methods has a positive meaning itself, each learner has a difficulty in concentrating on learning himself or herself. Because it is important that learners naturally understands and uses languages, a method is required that allows learners to naturally understand and recognize grammar while they learn a foreign language. However, in conventional grammar education, grammatical terms and knowledge hard to understand are obstacles to learners desiring to learn grammar naturally.

For example, grammar education for kids between the ages of six to twelve years old may achieve a result rapidly only if a special action is taken. Grammatical terms used to deliver knowledge to kids causes stress for the kids before their native language is not acquired. In addition, excessively-delivered grammatical knowledge is an obstacle to emotional development of kids. The kids may have interest and fun, but fail to continuously feel them in the end. Accordingly, actual education environments tend to focus on memorizing grammar rather than naturally understanding it. To solve the existing problem of grammar education, the grammar education is required to have fun. To achieve this, an amusement function is required to be added and the context of grammar is required to be naturally understood. The inventor has conducted a study of solving the problem for a longtime, and finally invented the present invention.

### DISCLOSURE

### Technical Problem

An objective of the present invention is to provide a novel grammar education means for allowing a learner to easily and naturally learn grammar of a foreign language.

Another objective of the present invention is to allow concepts of amusement and fun to be realized in grammar education of foreign languages. Puzzles and blocks are the most effective and conventional toys and learning materials for infants and kids (even adults). People learning a foreign language instead of a native language understands grammar of the foreign language in such a manner as to do a puzzle in the brain. The present invention provides grammar education as block and puzzle plays, based on the concept that regularly-designed blocks are assembled in the learner's brain.

A further objective of the present invention is to implement a grammar model which is related to a variety of linguistic principles, such as the usages of words constructing grammar and the grammatical context related to word arrangement, in the form of a toy model that allows the grammar model to be assembled using puzzles and blocks, and thus the scientific toy model is provided.

In addition, a further objective of the present invention is provide a learning model which allows learners to perform grammar education and writing practices together, and thus grammatical concepts are naturally understood through the writing practices.

Besides, other objectives which are not specified in the present invention are additionally considered within the scope of the detailed description and advantageous effects.

### Technical Solution

The objectives of the present invention are achieved by a block toy for learning a foreign language including word cards which include one or more geometrically-shaped coupling means and also words written thereon, and grammar blocks which include one or more geometrically-shaped corresponding coupling means that corresponds to the coupling means of the word cards and word card receiving portions for receiving the word cards, wherein the coupling means and the corresponding coupling means are fitted together in the word card receiving portions, and thus the word cards are inserted into the grammar blocks.

In addition, according to the block toy for learning a foreign language of one embodiment of the present invention, the coupling means are identical to or different from each other in shape according to words in order to be matched to grammatical features of the words written on the word cards.

Furthermore, it is preferable that, according to the block toy for learning a foreign language of the one embodiment of the present invention, the coupling means are configured with protrusions or concavities in geometric shape.

Besides, according to the block toy for learning a foreign language of one embodiment of the present invention, the block grammars have one or more additional coupling means in geometric shape disposed on the outside thereof, and the additional coupling means are used to couple the grammar blocks having word cards inserted thereinto together, and thus a sentence is completed.

In addition, according to the block toy for learning a foreign language of one embodiment of the present invention, the additional, geometrically-shaped coupling means inserted into the grammar blocks are configured with protrusions or concavities, and are coupled to other geometrically-shaped coupling means corresponding thereto in such a manner that protrusions on the one grammar block and concavities on the other grammar block are fitted together.

Furthermore, the block toy for learning a foreign language of one embodiment of the present invention may further include block-type word cards which are not inserted into the word card receiving portions of the grammar blocks even though having words written thereon, and have coupling means that are directly coupled to the one or more additional coupling means formed on the sides of the grammar blocks.

Besides, the block toy for learning a foreign language of one embodiment of the present invention may further include adopter grammar blocks which do not have words written thereon and are coupled to the word cards, the grammar blocks, or the block-type word cards.

In addition, a block toy for learning a foreign language according to the present invention includes word model blocks which have words written thereon and have a plurality of protrusions or concavities, and grammar model blocks which are coupled to the word model blocks using first coupling means that are configured with a plurality of protrusions or concavities and have second coupling means, characterized in that the second coupling means are configured with a plurality of protrusions or concavities and used to couple the grammar model blocks together.

### Advantageous Effects

According to the present invention, a user desiring to learn a foreign language learns a foreign language using both hands, and thus a block toy for learning a foreign language may have a greater learning effect in comparison to a case in which the user learns a foreign language using only his or her brain. Especially, the block toy for learning a foreign language may allow the user to learn a foreign language on the basis of the concept of amusement, and thus the user does not feel bored, and be also used as a learning material that allows the user to naturally understand grammar of a foreign language because the user couples words and grammar together like block play.

It is noted that although not described in detail in the specification of the present invention, potential effects that may be expected from technical characteristics of the present invention are considered equivalent to those described in the specification of the present invention.

### DESCRIPTION OF DRAWINGS

FIG. 1 illustrates the concept of a word model and a grammar model according to the present invention.

FIG. 2 illustrates an example in which a word card 100 and a grammar block 200 according to the present invention are coupled together to show a principle of the present invention.

FIG. 3 illustrates an exemplary configuration of the word card 100 according to one embodiment of the present invention.

FIG. 4 illustrates examples of protrusions 123 which are formed on the word card 100 shown in FIG. 3 differently from each other according to types of words.

FIG. 5 illustrates an exemplary configuration of the grammar block 200 according to the one embodiment of the present invention.

FIG. 6 illustrates an exemplary configuration of a block-type word card 150 according to the one embodiment of the present invention.

FIG. 7 illustrates an exemplary configuration of another grammar block 201 according to the one embodiment of the present invention.

FIG. 8 illustrates exemplary configurations of adopter grammar blocks 300 and 300a according to the one embodiment of the present invention.

FIG. 9 illustrates a state in which a sentence “A Chicken Is Eating Something Cooked” is formed in such a manner that blocks and cards are coupled to each other according to the one embodiment of the present invention.

The accompanying drawings are used for reference and by way of example in order that the technical ideas of the present invention are understood, and the scope of the present invention is not limited thereby.

### BEST MODE

An English sentence consists of four construction elements such as a subject, a verb, an object and a complement, and English has five basic sentence structures. Learners learn these sentence structures by analyzing and completing English sentences using parts of speech that are separated into detailed grammatical elements such as noun, article, pronoun, adjective, auxiliary verb, preposition, infinitive, gerund, relative pronoun, relative adverb, and so on. According to an aspect of a method for designing a system in the computer engineer field, a top-down method is used. This method plans the whole structure, and then designs detailed elements. That is, conventional English grammar education is to engrave learners' brains with a structure of “English grammar”. Learners have to artificially memorize such a grammar structure, and thus grammar education takes a large amount of time, has less fun, and ineffective.

The present invention aims for a bottom-top method. According to a bottom-top model of the present invention, learners naturally understand English grammar while trying to construct a sentence using “words” and “grammar”. That is, learners learn English grammar through touching a structure of English grammar, and this allows the learners to naturally understand and memorize a structure of English grammar.

Conventional English grammar education is performed in such a manner that learners learn English grammar from a variety of learning materials and teaching methods, while, according to the present invention, English grammar is learned on the basis of the concept of “thinking with hands”. The former is abstract thinking, while the latter is a learning design using a bottom-top model. According to the present invention, learners couple “words” and “grammar” together using their hands and repeat this coupling, thereby learning the context of grammar. The technical idea of the present invention is formed on the basis of a self-directed learning model that allows learners to couple words and grammar together using their hands and study grammar themselves.

### Mode for Invention

Hereinafter, embodiments of the present invention are described in detail with reference to the accompanying drawings, on the basis of the above-mentioned concept. In addition, in the following description, redundant descriptions and detailed descriptions of known functions that may unnecessarily make the gist of the present invention obscure will be omitted.

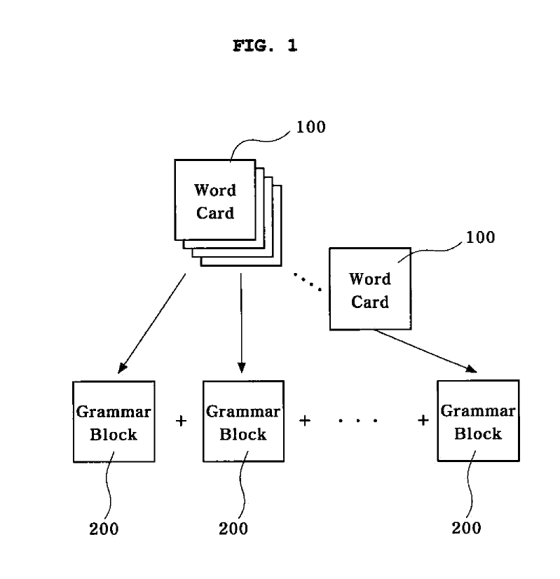

According to the present invention, a word model and a grammar model are individually described. FIG. 1 illustrates the concept of a word model and a grammar model according to the present invention. In the word model, each word is written on a word card 100 that may be carried by one hand of a user. The each word card 100 includes a plurality of identifiers that are embodied as a plurality of coupling means. Each of these identifiers is formed in a unique geometric shape according to grammatical principles of a corresponding word (the grammatical principles include part of speech, part of speech features, grammar examples and so on, and are selected from principles that have been already found in linguistics.). The term “word card” is arbitrarily used, and may be replaced with another term “word model block”.

The grammar model consists of a plurality of grammar blocks 200. These grammar blocks 200 are coupled to each other according to grammatical principles. The order of words constructing a sentence is decided through coupling the grammar blocks 200 to each other. The grammar blocks 200 fails to be coupled to each other if grammatical principles thereof are incorrect. Besides, the word cards 100 are coupled to the grammar blocks 200 using coupling means thereof. That is, the grammar blocks 200 having the word cards 100 inserted thereinto are coupled to each other, a sentence that is correct in grammar is constructed and also a piece of writing is completed. Similarly to the word cards 100, coupling means of the grammar blocks 200 are formed in unique or same geometric shape according to grammatical principles.

A block toy for learning a foreign language according to the present invention includes a plurality of word cards 100 and a plurality of grammar blocks 200. Each of the word cards has one word. Accordingly, the number of the word cards is appropriately determined on the basis of ages, cognitive abilities, and education levels of foreign language learners. The grammar blocks 200 are configured on the basis of grammatical principles corresponding to parts of speech in a sentence, and the number thereof is appropriately determined according to ages, cognitive abilities, and education levels of foreign language learners like the word cards.

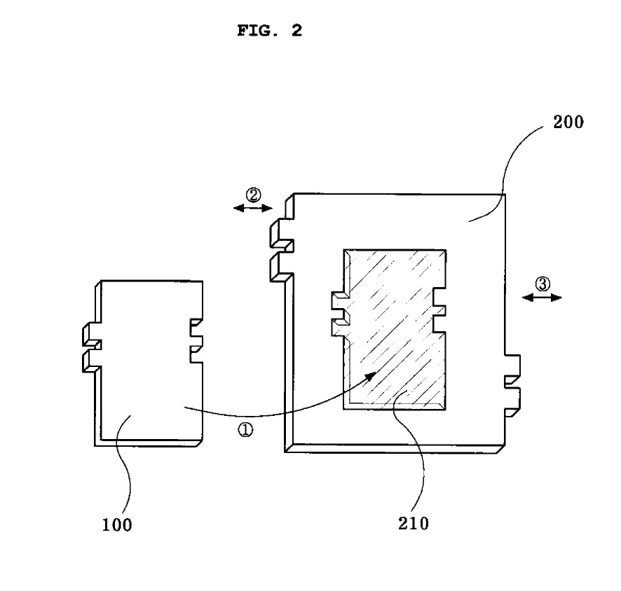

FIG. 2 illustrates the concept of the block toy for learning a foreign language shown in FIG. 1, which is shown focusing on coupling the word card and the grammar block together, to show an example of the principle of the present invention. The word card 100 has predetermined coupling means formed on predetermined positions thereof. The grammar block 200 has coupling means for coupling the word card 100 thereto.

The positions and geometric shapes of the coupling means may vary. The coupling means of the word card 100 and the corresponding coupling means of the grammar block 200 are configured to be coupled to each other. The coupling means of the word card 100 are described in detail in the following embodiment, and may be formed in the shape of protrusions and/or concavities. The word card 100 is inserted into a word card receiving portion 210 of the grammar block 200 (refer to the arrow \textcircled{1}). If the word card 100 fails to be inserted into the word card receiving portion 210 of the grammar block 200, it is meant that grammatical principles are incorrect between the word card and the grammar block, and another word card is required to be selected from a set of word cards.

In addition, the grammar block 200 may be coupled to other grammar blocks 200 using coupling means formed on the both sides thereof (refer to the arrows \textcircled{2} and \textcircled{3}). Coupling the grammar blocks 200 together makes a sentence. Some of the word cards are designed to be used as blocks instead of being inserted into the word card receiving portions, and directly coupled to the left and right sides of the grammar blocks 200. Although not shown in FIG. 2, such a block-type word card is described below. The Principle of the present invention in FIG. 2 is exemplarily shown. The word card and the grammar block may vary in shape and structure.

One preferred embodiment of the present invention is described on the basis of the above-mentioned concept and principle. The one embodiment is described by way of example, and a variety of modifications are possible.

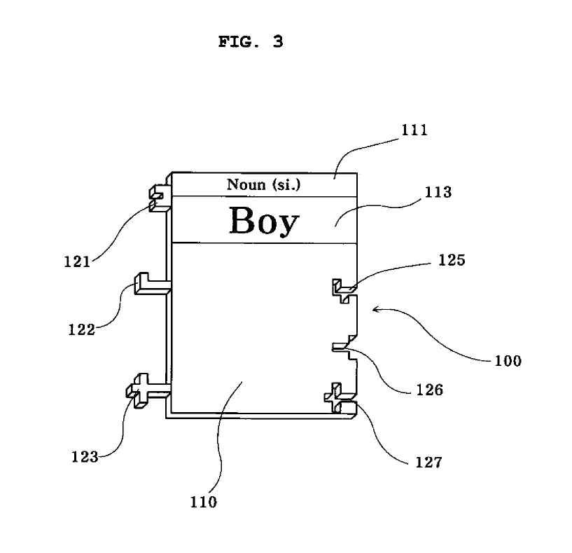

FIG. 3 illustrates an example of the word card 100 on which the word “Boy” is written according to one embodiment of the present invention. The word card 100 includes a word section 113 in which a word is written and a part of speech section 111 in which a part of speech of the word is displayed, wherein the two sections are formed on the surface 110 of the word card. In addition, the surface 110 may be painted with colors and have illustrations and/or texts formed thereon. Furthermore, the rear of the word card 100 may be painted with colors and the word card may have illustrations and/or texts formed on the rear thereof. The word card 100 includes coupling means 121, 122, 123, 125, 126, and 127, which are used to couple the word card and the grammar block together and are separated into two types such as protrusions and concavities, on the left and right sides thereof. The coupling means may be identical to or different from each other according to words. If words different from each other have grammatical features identical to each other, geometric shapes of the coupling means are also identical to each other. Whereas, if words have grammatical features different from each other, one or more of the coupling means are formed in geometric shapes different from each other. Accordingly, the coupling means are matched to grammatical features.

The protrusion 121 indicates the type of a part of speech into which a corresponding word is separated. The protrusions 121 of word cards may be formed in shapes different from or identical to each other according to parts of speech of words. The protrusion in FIG. 3 indicates that the word is a noun. The protrusion 122 indicates whether “a” and “the” may be added before the word. For example, in a case in which “a” is not added because the word is in the plural form, the protrusion 122 is formed in another shape.

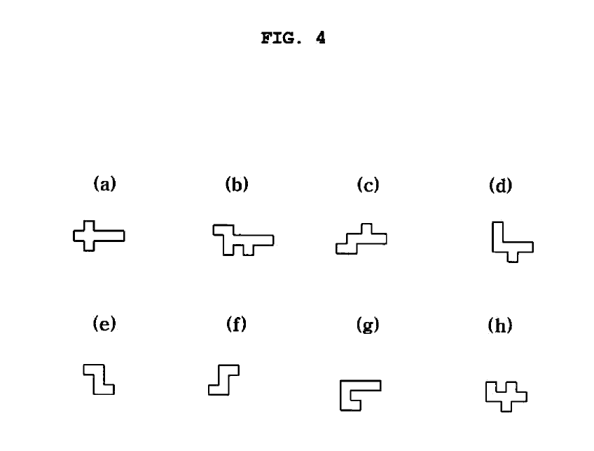

The protrusion 123 indicates the type of the word. For example, nouns have different grammatical features according whether the nouns are related to people, animals, or things. Especially, grammatical features of a noun may vary in a case in which a relative pronoun is added after the noun. Accordingly, the protrusion 123 is formed in different shapes according to the type of a word. FIG. 4 illustrates examples of the protrusions 123 which are formed in shapes different from each other according to types of words. FIG. 4a illustrates a protrusion related to people, FIG. 4b illustrates a protrusion related to animals, FIG. 4c illustrates a protrusion related to things, FIG. 4d illustrates a protrusion related to “what”, FIG. 4e illustrates a protrusion related to time, FIG. 4f illustrates a protrusion related to places, FIG. 4g illustrates a protrusion related to reasons, and FIG. 4h illustrates a protrusion related to methods.

These protrusions 123 are fitted to corresponding concavities of the grammar block. However, it is noted that the protrusion 123 is formed in various shapes according to the types of different word models. This is because words may have grammatical principles different from each other according to the types and parts of speech of the words.

Hereinafter, the concavities 125, 126, and 127 in FIG. 3 are described. These concavities are coupled to various verbs (for example, is, does, has, was, did, had, and so on) or relative pronouns (for example, who, whom, and that) added after a noun. Accordingly, these verbs and relative pronouns have protrusions corresponding to the concavities.

The present invention shows the grammatical features of the word “Boy” in the form of the protrusions 121, 122, and 123 and the concavities 125, 126, and 127 of the word card 100. When repeatedly using the block toy for learning a foreign language according to the present invention, a user is accustomed to protrusions and concavities corresponding to words, thereby naturally understanding features of the words.

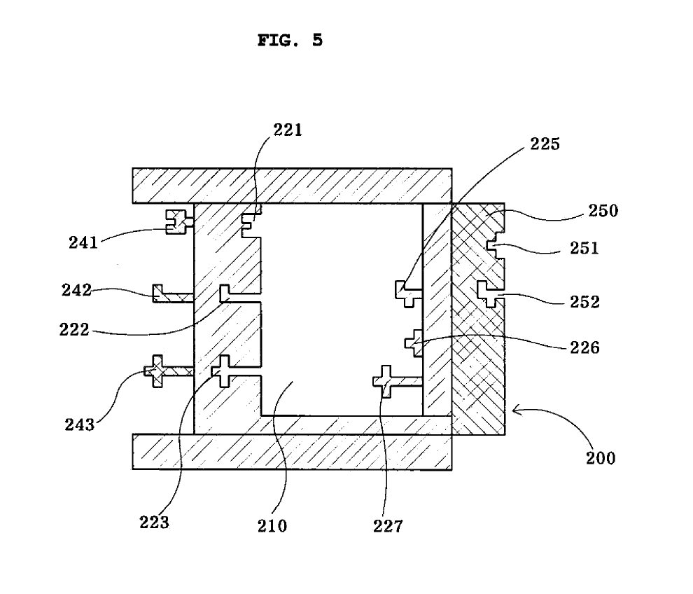

FIG. 5 illustrates an example of the grammar block 200 to which the word card 100 having the word “Boy” written thereon is coupled according to one embodiment of the present invention. The grammar block 200 has a word card receiving portion 210, which receives the word card 100, formed on the surface thereof. The word card receiving portion 210 has concavities 221, 222, and 223 and protrusions 225, 226, and 227 formed on the left and right sides thereof. The concavities 221, 222, and 223 of the grammar block 200 are coupled to the protrusions 121, 122, and 123 of the word card and the protrusions 225, 226, and 227 of the grammar block 200 are coupled to the concavities 125, 126, and 127 of the word card 100, and thus the word card 100 makes a pair with the grammar block 200.

As described above, the word card 100 reflecting features of a word through geometric shapes of the protrusions and the concavities is coupled to the grammar block 200, and thus grammatical features of the word are learned through block play. A variety of the word cards are coupled to the grammar blocks 200, and then the grammar blocks 200 are coupled to each other in a transversal manner, and thus the user naturally understands the positions of words in a sentence.

Protrusions 241, 242, and 243 on the left side and concavities 251 and 252 on the right side of the grammar block 200 are formed to couple the grammar block and other grammar blocks (or word cards), and coupling all the grammar blocks together makes a sentence.

The protrusions 241, 242, and 243 have functions similar to those in FIG. 3. The protrusion 241 indicates the type of the grammar block. For example, the protrusion indicates the subject or the predicate of a sentence. The position of the grammar block in FIG. 5 is the one where the word “Boy” is disposed on the basis of a grammatical structure and the grammar block indicates the subject. And the concavities 251 and 252 indicate features of words positioned after “Boy”. The concavities usually indicate features of verbs.

The grammar block 200 in FIG. 5 may be made out of a material identical to or different from the word card 100. For example, the material for the material includes plastic, paper, wood, metal, and so on. In addition, the grammar block 200 has a thickness similar to the word card 100, and preferably, is thicker than the word card 100. Each of the word cards 100 has one word, and one grammar block 200 may have a number of the word cards 100 coupled thereto. It is preferable that the grammar block 200 is more durable than the word card 100, considering materials and shapes of the grammar blocks and the word cards.

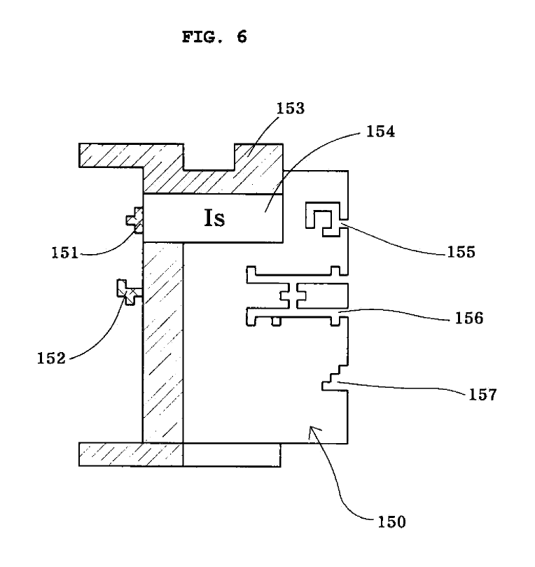

The word cards 100 and the grammar blocks 200 of the present invention are not limited to the drawings. The word cards and the grammar blocks may be provided in various shapes. FIG. 6 illustrates a block-type word card 150 according to the present invention. The block-type word card 150 is also a type of word cards, and includes a word section 154 and a part of speech section 153. The block-type word card is regarded as a word card because a word is written in the word section. Also, the block-type word card may be regarded as a block because directly coupled to the grammar blocks 200. Words related to verbs are usually applied to the block-type word card 150.

The block-type word card 150 of “Is” also includes coupling means, as described above. The block-type word card has protrusions 151 and 152 formed on the left side thereof and concavities 155, 156, and 157 formed on the right side thereof. The protrusions 151 and 152 indicate the type and part of speech of a corresponding word. The concavities 155, 156, and 157 are used to couple the block-type word card to a grammar block (or another block-type word card) which is related to a word positioned after the corresponding word, based on grammatical principles.

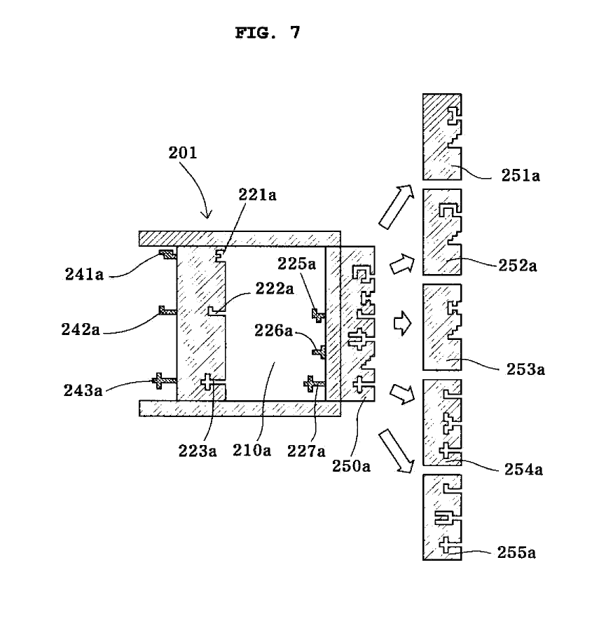

FIG. 7 illustrates another grammar block 201 of the block toy for learning a foreign language according to the present invention. The subject of an English sentence has grammatical features considerably different from the predicate, and the predicate is complicated and highly modifiable in comparison to the subject. The grammar block 210 in FIG. 7 is applicable to the predicate, and has basic features similar to the grammar block 200 in FIG. 5. Protrusions 241a, 242a, and 243a formed on the left side of the grammar block 201 are coupled to concavities formed on the right side of another block (or another card) that would be positioned to the left of the grammar block 201. A word card receiving portion 210a has concavities 221a, 222a, and 223a and protrusions 225a, 226a, and 227a formed on the left and right sides thereof, respectively, to receive a word card with coupling means that correspond to the protrusions and concavities.

The coupling means formed on the right side of the grammar block 201 in FIG. 7, that is a connecting board 250a which includes concavities coupled to the protrusions of a grammar block (or a word card) that would be positioned the right of the grammar block 201, may be configured to have different features. For example, assuming that a word card of a noun is inserted into the word card receiving portion 201a, another word after the noun may be one of the followings: a past particle; a present particle; a To-infinitive; a relative pronoun; and a preposition. And another block (or another card) is required to be coupled to the connecting board 250a, based on grammatical principles.

Accordingly, the grammar block 201 has a number of and a variety of geometrically-shaped connecting boards coupled to the right thereof. And FIG. 7 exemplarily illustrates five connecting boards. The connecting boards 251a, 252a, 253a, 254a, and 255a are used to join the grammar block to another block related to past particles (for example, done and not done), present particles (for example, doing and not doing), To-infinitives (for example, to do and not to do), relative pronouns (for example, who, whom, and that), and prepositions (of, in, on, and so on), respectively.

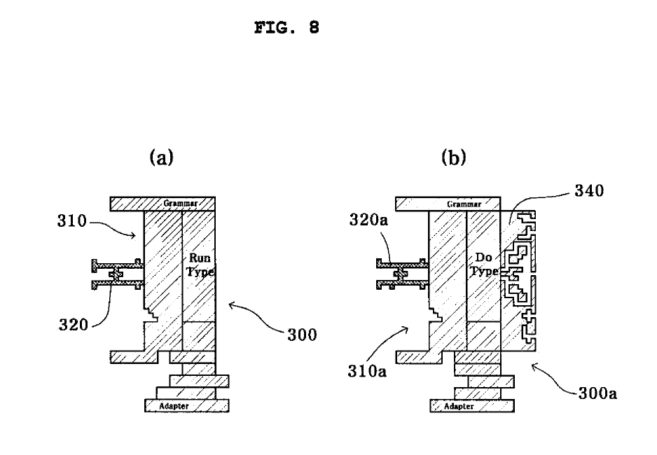

According to the one embodiment of the present invention, the block toy for learning a foreign language may include other components in addition to the word cards 100, the grammar blocks 200, and block-type word cards 150. FIG. 8 illustrates an example of adopter grammar blocks 300 and 300a as other components. The adopter grammar blocks 300 and 300a do not have words written thereon, differently from the blocks (or cards). The adopter grammar blocks 300 and 300a are used to connect the blocks (or cards) together.

English grammar is configured on the basis of five basic sentence structures. Especially, the adopter grammar blocks 300 and 300a are used to support verbs according to the five basic sentence structures. FIG. 8 illustrates some examples of the supporting. The adopter grammar blocks 300 and 300a are coupled to the block-type word cards indicating verbs through receiving portions 310 and 301a formed in the left sides thereof. Protrusions 320 and 320a formed in the left of the adopter grammar block are coupled to the concavities formed in the right side of the block-type word card 150.

The adopter grammar block 300 in FIG. 8a may be used as a block that is positioned in the end of a sentence. Accordingly, in such a case, the adopter grammar block does not have coupling means added to the right thereof. The adopter grammar block 300a in FIG. 8b is positioned in the middle of a sentence to join elements constructing a sentence together, thereby having various types of connecting boards 340 positioned to the right thereof. Accordingly, the grammar blocks 200 are coupled to the connecting boards 340.

As described in detail above, according to the present invention, a sentence is constructed by words in the following method:

1. A word card 100 having a word written thereon is coupled to a grammar block 200;

2. The grammar block 200 is coupled to the left or right of another grammar block 200;

3. A block-type word card 150 may be coupled to the right of the grammar block 200 and to the left of adopter grammar blocks 300 and 300a;

4. The block-type word card 150 may be coupled to the left or right of another block-type card 150;

5. The adopter grammar blocks 300 and 300a are coupled to the block-type word card 150 or the grammar block 200; and

6. The elements constructing a sentence are coupled to each other to make a sentence.

A user uses his or her hands to couple the elements together according to the above-mentioned method, and thus the order of words is established and a sentence is made. The coupling means are formed on the basis of grammatical principles, and thus, if the order of the words is ungrammatical, the coupling means fail to be coupled to each other. The user couples blocks together like block play, thereby understanding grammatical principles and making sentences with correct grammar.

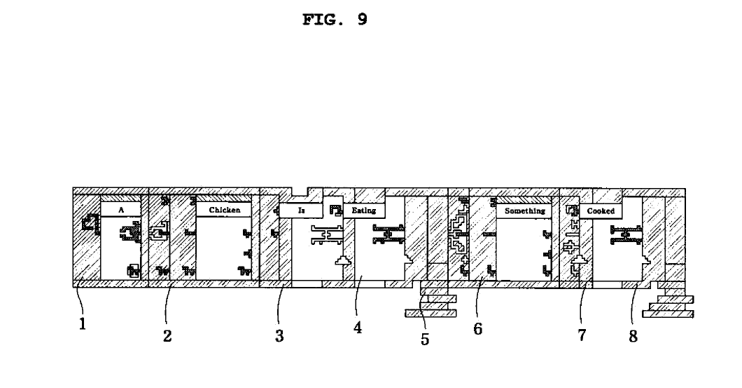

FIG. 9 illustrates an example of a sentence “A Chicken Is Eating Something Cooked” which is made using the block toy for learning a foreign language according to the present invention. Part 1 including “A” is configured in such a manner that a word card having “A” written thereon is coupled to a grammar block, and the grammar block is coupled to part 2 including “Chicken”. The part 2 is also configured in such a manner that a word card having “Chicken” written thereon is coupled to a grammar block. Coupling the two parts 1 and 2 together, a sentence element “A Chicken” is made.

Part 3 including “Is” is a block-type word card having the word “Is” written thereon, and is coupled to the right of the part 2. And part 4 including “Eating” is coupled to the part 3. Grammatical principles are correct between the parts 3 and 4, and thus protrusions and concavities are coupled to each other. The part 4 is also a block-type word card. In consequence, a sentence element “A Chicken Is Eating” is made.

Part 5 used to support a verb (Eating) according to a correct sentence structure is an adopter grammar block. The left side of this adopter grammar block is coupled to the right of the part 4 including “Eating”, and then protrusions formed in the left side of part 6 including “something” are coupled to concavities formed in the right side of the adopter grammar block. The part 6 is configured in such a manner that a word card having “Something” written thereon is inserted into a grammar block. Protrusions formed in the left side of a block-type word card having “Cooked” written thereon (part 7) are coupled to the right of the part 6, and then another adopter grammar block (part 8) indicating the end of a sentence is coupled to the part 7. Eventually, a sentence “A Chicken Is Eating Something Cooked” is completed. English grammar has already-established principles.

However, considering that English has a number of grammatical principles and words as well, the contents and examples of the principles are complicated. The present invention uses established grammatical principles rather than provides new grammatical principles. The present invention uses a word model and a grammar model in order to overcome complexity of the grammatical principles and difficulties of conventional grammar education. In addition, the two models are embodied as blocks that allow a learner to enjoy block play. The grammatical principles, such as features of words, sentence structures, the order of words in a sentence, and so on, are embodied as geometric shapes of coupling means formed on blocks (or cards). Accordingly, if the geometric shapes of the coupling means formed on the blocks (or cards) are different from each other, the blocks (cards) have grammatical principles different form each other.

According to the present invention, the embodied coupling means are formed in protrusions and concavities like block toys. The more words are used, the more various geometric shapes the protrusions and concavities are formed in. In addition, more grammar blocks and word cards are used. In a theoretical aspect, the number of used grammar blocks and word cards are high, and however, the grammar blocks and word cards may be less used if the number of words is low. That is, this means that the number of the grammar blocks and word cards may vary according to ages, cognitive abilities, and education levels of foreign language learners. Kids learn English grammar and writing skills in a self-directed manner using the less number of word cards and grammar blocks.

Whereas, more words, more complicated sentence structures, and other elements, such as relative pronouns or conjunctions, and various prepositions, may be applied to students of relatively-higher age or adults. In this case, the number of word cards and grammar blocks may be increased, and also the type of the word cards and grammar blocks may be more diverse than the embodiment.

A variety of modifications are made to the coupling means shown in the drawings and described in the embodiment of the present invention. The scope of the present invention is not limited by protruding and concaving shapes of the coupling means shown in the drawings. In addition, according to the embodiment of the present invention, the coupling means are formed in the left or right side of the grammar blocks and word cards in protruding and concaving shapes, and thus the grammar blocks and word cards are arranged only in a transversal manner. However, this is suggested to facilitate understanding of a user, because sentences are usually constructed in a horizontal manner. In another embodiment, the coupling means may be provided to the top and bottom of the grammar blocks and word cards configuring the block toy of the present invention. In addition, the coupling means may be formed on the left, right, top and bottom sides of the grammar block and word cards configuring the block toy of the present invention.

Furthermore, some of protrusions or concavities of the present invention may be painted with colors. Classifying parts of speech by colors is a typical example. However, all the coupling means are not paint with colors. This is because the present invention relates to a block toy.

Besides, as described above, different colors, symbols, illustrations, and so on may be added to the word cards or the grammar blocks of the present invention.

In addition, the word cards and the grammar blocks according to the present invention are not limited to sizes and thicknesses only if formed in sizes enough to be coupled to each other by the hands of a learner. Slim word cards and block grammars of a thickness less than 1 mm are acceptable, and, in this case, the word cards and grammar blocks are preferably made out of a strong material because protrusions thereof may be damaged. Other thicker grammar blocks and word cards have an advantage that coupling means may have less damaged. However, the volume of the block toy is increased. It is preferable that thicker grammar blocks and word cards are provided to infants or kinds, because the less number of words are required therefor. Whereas, it is preferable that slimmer word cards and grammar blocks are provided to learners older than infants and kids, because the more number of words are required.

In addition, an electric device may be mounted into a word card according to another embodiment of the present invention. The electric device includes a battery, a voice outputting means, a memory for storing voices, and a control unit. The pronunciation of a word written on the word card may be outputted through a voice. Also, when a sentence is constructed by coupling the word cards and the grammar blocks together, the sentence may be read through a voice.

The embodiments of the present invention are usually described in relation to English as a foreign language. However, this is suggested for the consistent and logical description. The embodiments of the present invention include English as well as a variety of foreign languages with established grammar principles. Accordingly, the scope of the present invention is not limited to English.

Besides, the scope of the present invention is not limited to the disclosures and expressions of the foregoing embodiments. In addition, it is noted that the scope of the present invention is not also limited by modifications and replacements apparent to those skilled in the art.

1. Block toy for learning a foreign language, comprising:
word cards which have one or more geometrically-shaped coupling means and also words written thereon; and
grammar blocks which have one or more geometrically-shaped corresponding coupling means that corresponds to the coupling means of the word cards and also have word card receiving portions for receiving the word cards formed inside,
wherein the coupling means and the corresponding coupling means are fitted together in the word card receiving portions, and thus the word cards are inserted into the grammar blocks.

2. Block toy for learning a foreign language according to claim 1, wherein the coupling means are identical to or different from each other in shape according to words in order to be matched to grammatical features of the words written on the word cards.

3. Block toy for learning a foreign language according to claim 1, wherein the coupling means are configured with protrusions or concavities of geometric shape.

4. Block toy for learning a foreign language according to claim 3, wherein the protrusions or the concavities are formed on the sides of the word cards.

5. Block toy for learning a foreign language according to claim 1, wherein one or more additional coupling means of geometric shape are disposed on the outside of the grammar blocks, and
the additional coupling means are used to couple the grammar blocks having word cards inserted thereinto together, and thus a sentence is completed.

6. Block toy for learning a foreign language according to claim 5, wherein the additional, geometrically-shaped coupling means on the grammar blocks are configured with protrusions or concavities, and are coupled to other geometrically-shaped coupling means corresponding thereto in such a manner that protrusions on the one grammar block and concavities on the other grammar block are fitted together.

7. Block toy for learning a foreign language according to claim 1, wherein the block toy for learning a foreign language may further comprise block-type word cards which are not inserted into the word card receiving portions of the grammar blocks even though having words written thereon, and have coupling means that are directly coupled to the one or more additional coupling means formed on the sides of the grammar blocks.

8. Block toy for learning a foreign language according to claim 7, wherein the block toy for learning a foreign language further comprises adopter grammar blocks which do not have words written thereon and are coupled to the word cards, the grammar blocks, or the block-type word cards.

9. Block toy for learning a foreign language according to claim 1, wherein the foreign language is English.

10. Block toy for learning a foreign language, comprising:
word model blocks which have words written thereon and have a plurality of protrusions or concavities; and
grammar model blocks which are coupled to the word model blocks using first coupling means that are configured with a plurality of protrusions or concavities, and have second coupling means,
wherein the second coupling means are configured with a plurality of protrusions or concavities and used to couple the grammar model blocks together.

11. Block toy for learning a foreign language according to claim 1, wherein the word cards comprises a push switch and a voice outputting device for outputting a voice based on the control of the push switch.

12. Block toy for learning a foreign language according to claim 11, wherein, when the push switch is pushed, the pronunciation of a word written on the word card is outputted through a voice, and, when a sentence is constructed by coupling the word cards and the grammar blocks together, the sentence is read through a voice.

13. Block toy for learning a foreign language according to claim 1, wherein images, colors, or texts related to words are illustrated, painted, or written on the surfaces of the word cards.
